(19) United States
(12) Patent Application Publication
(10) Pub. No.: US 2014/0032738 A1
(43) Pub. Date: Jan. 30, 2014

(54) METHOD, APPARATUS AND SYSTEM FOR ESTIMATING SUBSCRIPTION HEADROOM FOR A STORAGE POOL

(71) Applicants: Sudip S. Chahal, Gold River, CA (US); David Stanasolovich, Albuquerque, NM (US); Don G. Meyers, Rescue, CA (US); Joshua Boelter, Portland, OR (US)

(72) Inventors: Sudip S. Chahal, Gold River, CA (US); David Stanasolovich, Albuquerque, NM (US); Don G. Meyers, Rescue, CA (US); Joshua Boelter, Portland, OR (US)

(21) Appl. No.: 13/557,058

(22) Filed: Jul. 24, 2012

(51) Int. Cl. G06F 15/173

(52) U.S. Cl. 709/224

(57) ABSTRACT

Techniques and mechanisms for determining that subscription headroom is available for a storage pool. In an embodiment, the storage pool is classified based on a current subscription level for the storage pool and respective levels of one or more metrics for the storage pool. A signal is generated in response to a storage pool classification indicating availability of subscription headroom. In another embodiment, a target subscription level is determined for generating the signal, where the target subscription level is based on the current subscription level, a first metric of the one or more metrics, and a high utilization threshold corresponding to the first metric.

### BACKGROUND

1. Technical Field

Embodiments of the present invention relate generally to managing data storage. More particularly, certain embodiments relate to techniques for detecting available subscription headroom for a storage pool.

2. Background Art

Growth in the demand for data storage has been explosive in recent years, and the industry has responded by implementing over-subscription (also referred to as “thin-provisioning”) in an effort to improve storage utilization and slow the growth in raw storage and associated costs. The over-subscription concept relies on the expectation that most clients of a storage pool never completely use the allocated storage to which they have subscribed, so judicious over-subscription can result in improved efficiencies.

However, over-subscription entails the risk that some amount of data to be stored could eventually exceed the capacity of a storage pool's actual, physical storage volume, resulting in application outage, job failure, restart or downtime of one or more storage devices, and/or the like. Even if storage device outage is averted, data for one or more customers is often migrated to another storage pool with more unsubscribed capacity. Such migration translates into higher churn, administrative overhead, costs, etc. Because of these risks, storage administrators are generally reluctant in leveraging over-subscription, resulting in sub-optimal utilization and increased costs.

To date, implementation of thin-provisioning has relied upon estimation of subscription headroom, where such estimation is left to the customer per their risk-tolerance requirements and/or associated policies. Complicating the situation is that consumption patterns (and implied customer efficiency) are highly variable—not only from customer to customer or datacenter to datacenter, but from individual storage pool to storage pool. It is not at all unusual for one pool to efficiently implement over-subscription (balancing information storage and over-subscription risk) and for another pool to do so inefficiently. Pool sizes can vary substantially as well.

The variation between requirements of storage pool customers, the constant change in storage pool operation characteristics over time, and various other associated factors have to-date limited the effectiveness of current techniques for implementing over-subscription.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating elements of a system for providing a storage pool service according to an embodiment.

FIG. 2 is a block diagram illustrating elements of a pool manager for detecting subscription headroom for a storage pool according to an embodiment.

FIG. 3 is a flow diagram illustrating elements of a method for detecting subscription headroom according to an embodiment.

FIG. 4 is a flow diagram illustrating elements of a method for detecting subscription headroom according to an embodiment.

FIG. 5 is a block diagram illustrating elements of a computer platform for generating subscription headroom information according to an embodiment.

FIGS. 6A through 6C are each listings of pseudocode illustrating elements of respective operations to calculate subscription headroom information according to various embodiments.

### DETAILED DESCRIPTION

Embodiments discussed herein variously perform automatic analysis of subscription headroom for a storage pool. As used herein, “subscription headroom” refers an amount of storage—e.g. including physical storage, merely hypothetical (e.g. speculative) storage, or some combination thereof—which is safely available for subscription in addition to any currently subscribed physical and/or speculative storage. Subscription headroom may be an additional storage capacity value—e.g. above a current subscription level for a storage pool—which can be subscribed to some or all clients of a storage pool before some risk requires that additional physical storage be purchased, rented or otherwise allocated to the storage pool.

In an embodiment, subscription headroom information may be calculated based on one or more factors including, but not limited to, one or more of a customer risk-tolerance policy, a pool size, a current subscription (or “allocation”) level, a current information storage level (and/or associated data storage efficiency), a rate of growth of data storage, a pool access performance metric, and/or the like.

By way of illustration and not limitation, pool management logic according to an embodiment may perform one or more operations to determine a current subscription level for a storage pool and a respective current level of each of one or more metrics for the storage pool. The one or more metrics may, for example, include an information storage metric describing an amount of the storage pool—e.g. in bytes—which is currently storing information on behalf of a client (for example, all clients) of the storage pool. Such an information storage metric is sometimes referred to as a “consumption” metric. Alternatively or in addition, the one or more metrics may include a growth metric (such as a time-to-fill value, a gigabytes-per-hour value, and/or the like) indicating a rate of change in an amount of the storage pool which is currently storing information. Alternatively or in addition, the one or more metrics may include a performance metric describing, for example, a characteristic of one or more client accesses of the storage pool. Such characteristic may include one or more of read and/or write delays, address translation, throughput and/or the like. By way of illustration and not limitation, a performance metric may be an average (e.g. a running average) of read/write latency as a percentage of some baseline reference time period.

In an embodiment, some or all of the one or more metrics may each correspond to a respective quality of service specifying one or more threshold values for that performance metric. For example, quality of service requirements may be processed—e.g. combined, weighted, etc.—to evaluate thresholds for one or more threshold metric values. One or more threshold values may be updated dynamically—e.g. based on hysteresis or other analysis of storage pool performance. Techniques for generating and/or updating metric threshold values are not limiting on certain embodiments.

Such pool management logic may further classify the storage pool—e.g. where such classifying includes testing for one or more low utilization conditions which each correspond to a respective one of the subscription level and the one or more metrics. In an embodiment, such testing includes testing whether each such low utilization condition is indicated. Where the testing indicates a combination of all of the low utilization conditions which are tested, the pool management logic may, for example, generate a signal indicating availability of subscription headroom. In an embodiment, the subscription headroom indicated by the signal may be determined based on the current subscription level, the current level of a first metric of the one or more metrics, and a high utilization threshold corresponding to that first metric.

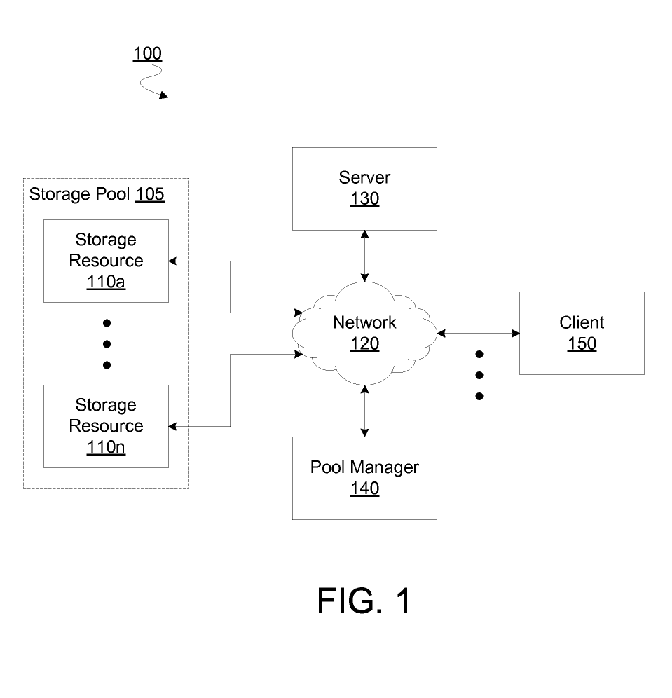

FIG. 1 illustrates elements of a system 100 for providing pooled storage resources according to an embodiment. System 100 may, for example, implement one or more structures and/or techniques for automatically detecting and/or estimating subscription headroom.

In an embodiment, system 100 includes a storage pool 105 comprising one or more resources—represented by illustrative storage resources 110a, . . . , 110n—for storing information on behalf of one or more storage pool clients. Each of storage resources 110a, . . . , 110n may variously include, for example, one or more of a hard disk drive, solid state drive, CD-ROM drive, DVD-drive, server, data center, or any of a variety of other resources for information storage. Storage resources 110a, . . . , 110n may include one or more resources located in a single datacenter or other such facility and/or one or more resources located in different geographic locations. The particular types of storage resources in storage pool 105 and their respective locations and/or networking with one another may not be limiting on certain embodiments.

In an embodiment, storage resources 110a, . . . , 110n may be variously made available to one or more clients of storage pool 105—e.g. including a client 150. By way of illustration and not limitation, client 150 may access storage pool 105 via a network 120 coupled thereto. Network 120 may, for example, include one or more of a dedicated storage area network (SAN), a local area network (LAN), a wide area network (WAN), a virtual LAN (VLAN), a wireless network, a cloud network, an Internet and/or the like. The particular location and/or networking of client 150 with respect to other elements of system 100 may not be limiting on certain embodiments.

System 100 may include one or more servers—e.g. including a server 130—to facilitate access to storage pool 105 by client 150, where such access is based upon allocation of some storage volume to client 150. By way of illustration and not limitation, server 130 may operate as a gateway though which client 150 is provided accesses to storage pool 105. Alternatively or in addition, server 130 may operate as a name server to direct an access request of client 150 to one or more of storage resources 110a, . . . , 110n. Alternatively or in addition, server 130 may operate to provide one or more security services—e.g. including authentication, authorization, key provisioning and/or the like—for allowing client 150 access to storage pool 105.

At a given point in time, a current subscription level for storage pool 105 may be comprised of a volume of storage which is allocated to client 150. System 100 may include one or more mechanisms to determine whether, in addition to such a current subscription level, subscription headroom is available for storage pool 105. By way of illustration and not limitation, system 100 may include pool manager 140 comprising circuit logic—e.g. including one or more of hardware, firmware and executing software—to determine a classification of storage pool 105. Although pool manager 140 is coupled to server 130 via network 120, in an alternate embodiment, pool manager 140 may be incorporated within server 130.

Determination of such a classification may include pool manager 140 determining a current subscription level and one or more metrics. Based on the determined classification, pool manager 140 may classify storage pool 105—e.g. where such classification is to determine whether one or more levels of utilization of storage pool 105 indicate availability of such subscription headroom. Based on such classification, pool manager 140 may, in an embodiment, generate a signal identifying or otherwise indicating the subscription headroom. Generating such a signal may, for example, include determining a target subscription level which is based on the current subscription level, a first metric of the one or more metrics, and a threshold value corresponding to the first metric.

In an embodiment, the signal comprises a message sent from pool manager 140 to server 130. Server 130 may respond to such a message by adjusting access to storage pool 105 and/or one or more characteristics of storage pool 105. By way of illustration and not limitation, server 130 may respond to an indication of subscription headroom by allowing one or more clients of storage pool 105 to subscribe to additional storage volume.

Server 130 may respond to one or more other types of communications from pool manager 140, according to different embodiments. For example, in response to a communication from pool manager 140 indicating high utilization of storage pool 105, server 130 may rebalance one or more resources of storage pool 105.

Storage pool 105 may be a sub-pool of a larger storage pool (not shown) comprising system 100. For example, storage pool 105 may be dedicated to providing storage for one or more client types, one or more data types and/or the like. In such an embodiment, detection of subscription headroom specific to storage pool 105 may be separate from—e.g. independent of—other detection of subscription headroom for the larger storage pool.

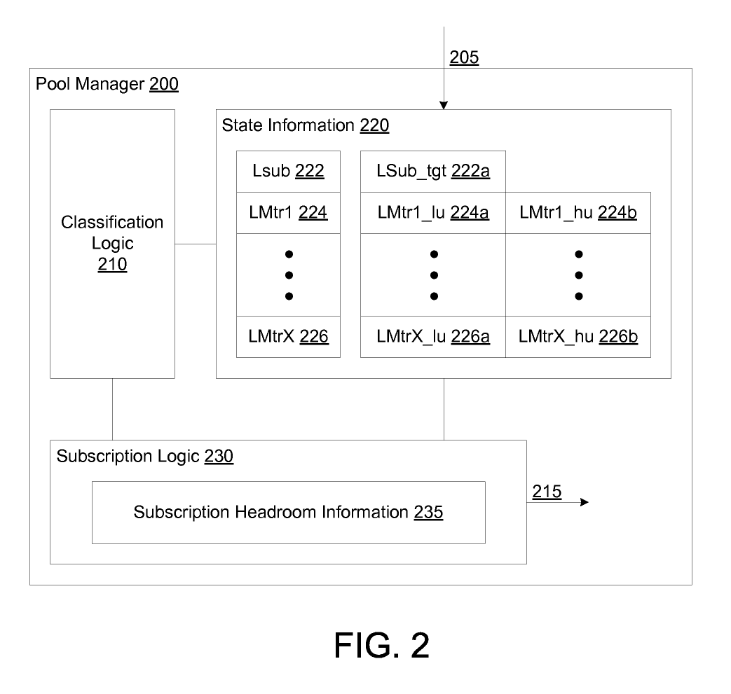

FIG. 2 illustrates elements of a pool manager 200 according to an embodiment. Pool manager 200 may provide functionality to automatically detect for and/or estimate subscription headroom information for a storage pool. For example, pool manager 200 may include some or all of the features of pool manager 140.

Pool manager 200 may include classification logic 210 to determine a classification of a storage pool. By way of illustration and not limitation, pool manager 200 may include, or otherwise have access to, state information 220 comprising a current subscription level LSub 222 for the storage pool and one or more current levels 224—for example, including one or more of levels LMtr1 224, . . . , LMtrX 226—each for a respective metric of one or more metrics for the storage pool. Some or all of state information 220 may be provided to pool manager as input 205—e.g. from any of a variety of storage resources, servers, clients and/or other stakeholder in system 100 or other such pooled storage system.

Classification logic 210 may access any of a variety of additional or alternative information for use in detecting and/or estimating subscription headroom. For example, classification logic 210 may retrieve threshold information and/or target information related to various operation parameters, where such information is accessed from state information 220 or other such repository. Such target and/or threshold information may, for example, be provided as or otherwise based on communications by a storage pool client (customer), storage pool administrator, or other stakeholder specifying one or more risk-tolerance policies, baseline pool utilization projections, quality-of-service requirements and/or the like.

To illustrate features of certain embodiments, classification logic 210 is shown accessing a target subscription level LSub_tgt 222a, a low utilization threshold LMtr1_lu 224a and high utilization threshold LMtr1_hu 224b corresponding to LMtr1 224 and a low utilization threshold LMtrX_lu 226a and high utilization threshold LMtrX_hu 226b corresponding to LMtrX 226. However, classification logic 210 may access any of a variety of additional or alternative target and/or threshold values, according to different embodiments. Some or all of state information 220 may be updated dynamically, in an embodiment.

Based on state information 220, classification logic 210 may automatically classify the storage pool as being in a particular pool class—e.g. where such classifying selects from one of a plurality of pool classes. Such pool classes may, for example, include an “open” class associated with a storage pool being open to subscription of additional storage volume and having available subscription headroom. Additionally or alternatively, such pool classes may include a “closed” class associated with a storage pool being closed to subscription of any additional storage volume and not having any available subscription headroom. In an embodiment, the closed class may more specifically be associated with a storage pool for which some rebalancing of resources is indicated as not being needed. Such a closed class may, for example, be distinguished from a “rebalance” class which is also for a storage pool closed to additional subscription and has no subscription headroom, but where such rebalance is needed. Such rebalance may, for example, include adding physical storage volume to the storage pool, adjusting one or more metric threshold values and/or the like.

In an embodiment, classification logic 210 selects between open, closed, rebalance and/or one or more other pool classes based on different threshold values. One or more metrics may each correspond to a respective low utilization threshold and/or a respective high utilization threshold. Classification logic 210 may automatically compare the respective current values of one or more metrics each with a corresponding low utilization threshold. Such comparison may together indicate utilization of the storage pool which is sufficiently low—e.g. where each of the comparisons indicates low utilization—for the storage pool to be classified as open. Such classification may result in signaling to indicate that subscription headroom is available.

Additionally or alternatively, classification logic 210 may compare the respective current values of one or more metrics each with a corresponding high utilization threshold. Such comparisons may in the aggregate indicate utilization of the storage pool which is sufficiently high—e.g. where at least one such comparison indicates high utilization—for the storage pool to be classified in the rebalance class. Such classification may result in signaling to prevent additional storage volume subscription trigger a rebalancing of storage pool resources. Additionally or alternatively, classification logic 210 may detect some intermediary level of storage pool utilization between that for the open class and that for the rebalance class.

In an embodiment, pool manager further includes subscription logic 230 to automatically determine subscription headroom information 235 based upon a storage pool class indicated by classification logic 210. For example, where classification logic 210 indicates an open class for the storage pool, subscription logic 230 may identify a target subscription level which is based on a current subscription level LSub 222, a metric and a high utilization threshold corresponding to that metric (such as LMtr1 224 and the corresponding LMtr1_hu 224b). Such a target subscription level may, for example, replace the current value of target subscription level LSub_tgt 222a.

Additionally or alternatively, subscription logic 230 determining subscription headroom information 235 may include subscription logic 230 determining one or more of a ratio value Subscribed_hdrm % (e.g. in percent of pool size) of the subscription headroom—e.g. as a percentage of the storage pool size—a volume amount Subscribed_hdrm (e.g. in bytes) of the subscription headroom, a maximum allowed subscription amount Subscribed_max (e.g. in bytes) including a current maximum allowed subscription amount and the newly-detected subscription headroom, and/or other such headroom information.

Subscription logic 230 may generate signal 215 describing or otherwise indicating subscription headroom information 235. In an embodiment, signal 215 stores subscription headroom information 235—e.g. in state information 220. Alternatively or in addition, signal 215 may be provided to circuit logic (not shown) included in and/or coupled to pool manager 200—e.g. including logic of server 130—for implementing additional subscription, rebalancing and/or other pool management operations.

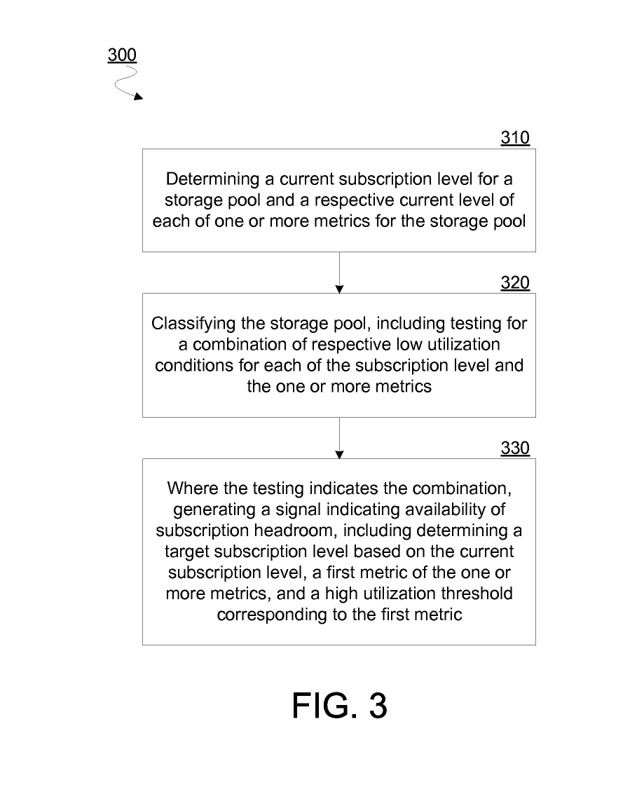

FIG. 3 illustrates elements of a method 300 to detect subscription headroom according to an embodiment. Method 300 may, for example, determine an opportunity to provide additional storage subscription in a storage pool such as storage pool 105. In an embodiment, method 300 is performed with circuit logic having some or all of the features of pool manager 200.

Method 300 may include, at 310, determining a current subscription level for a storage pool and a respective current level of each of one or more metrics for the storage pool. The one or more metrics may, for example, include an information storage metric, a growth metric and/or an access performance metric. The current level of any of a variety of additional or alternative metrics may be determined at 310, according to different embodiments. The one or more metrics may each correspond to a respective low utilization threshold. A low utilization threshold corresponding to a metric may, for example, be distinguished from a high utilization threshold corresponding to the same metric. In an embodiment, a low utilization threshold and high utilization threshold for a metric may define, at least in part, an intermediate level of storage pool utilization.

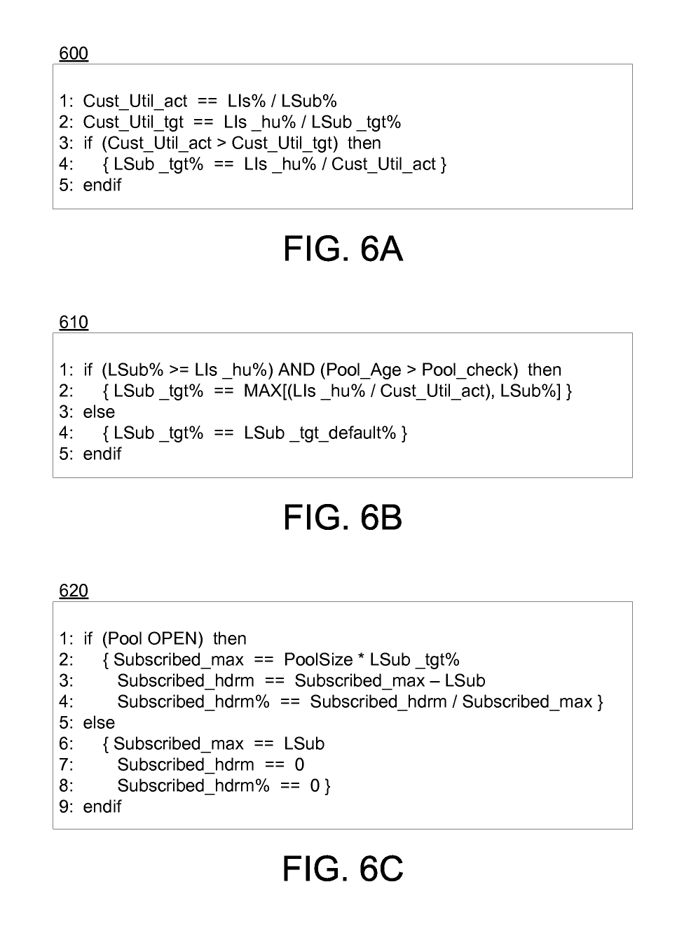

Method 300 may further include, at 320, classifying the storage pool, including testing for a combination of respective low utilization conditions for each of the subscription level and the one or more metrics. The testing at 320 may comprise, for example, comparing the current subscription level with a threshold subscription level, and, for each of the one or more metrics, comparing the current level for the metric to a low utilization threshold corresponding to that metric. In an embodiment, the testing at 320 detects for whether each such comparison indicates low storage pool utilization.

Where the testing at 320 indicates the combination of low utilization conditions, method 300 may, at 330, generate a signal indicating availability of subscription headroom. In an embodiment, generating the signal at 330 includes determining a target subscription level—e.g. based on the current subscription level, a first metric of the one or more metrics, and a high utilization threshold corresponding to the first metric. The target subscription level may be calculated, for example, based on a product of the current subscription level and a ratio of the high utilization threshold for the first metric to the current level of first metric—e.g. as discussed herein with respect to FIGS. 6A and 6B. Any of a variety of additional or alternative techniques may be used to calculate the target subscription level, according to different embodiments. Such calculating may be performed in response to the classifying at 320, although certain embodiments are not limited in this regard. In an embodiment, method 300 includes calculating an estimate of subscription headroom based on the current subscription level and a target subscription level—e.g. as discussed herein with respect to FIG. 6C. Such calculation may, for example, be performed in response to the signal generated at 330. In an alternate embodiment, the signal generated at 330 may describe or otherwise indicate an already-calculated subscription headroom estimate.

In an embodiment, the one or more metrics for classifying the storage pool at 320 includes a metric other than any metric which is a component of the target subscription level. By way of illustration and not limitation, a particular growth metric (or a particular access performance metric, etc.) may be determinative whether storage pool utilization indicates availability of subscription headroom, although a function or algorithm for actually calculating a value for such subscription headroom may be independent of that growth metric.

The classifying at 320 may further include performing a respective high utilization evaluation for each of the one or more metrics. In an embodiment, such high utilization evaluations may comprise, for each of the one or more metrics, comparing the current level for the metric to a high utilization threshold corresponding to that metric. In an embodiment, the classifying at 320 detects for whether any of the metric comparisons indicates high storage pool utilization. Where any of the high utilization evaluations indicates high utilization, method 300 may generate a signal indicating a rebalance of one or more storage pool resources.

FIG. 6A is a listing of pseudo-code 600 representing elements of a technique for calculating a target subscription level LSub_tgt % according to an embodiment. The technique of pseudo-code 600 may be performed by pool manager 200, or a similar device. The calculated value LSub_tgt % represents a target subscription level in terms of some ratio—e.g. a percentage—with respect to the storage pool size or some other reference storage volume amount. In an alternate embodiment, pseudo-code 600 may calculate a target subscription level LSub_tgt in terms of an absolute value of bytes, Gigabytes and/or the like. Unless indicated otherwise herein, use of the symbol “%” in any variable name shown in FIGS. 6A through 6C indicates that the variable in question is a representation of a value in terms of percentage of the storage pool size.

The calculated LSub_tgt % —and/or information based on or otherwise indicating LSub_tgt % —may be described in the signal generated at 330 of method 300. For example, LSub_tgt % may be calculated in response to classification of a storage pool—e.g. at 320 of method 300—as being in an open state.

Line 1 of pseudo-code 600 specifies a value Cust_Util_act as being a ratio of a current level LIs % of an information storage metric to a current subscription level LSub %. Line 2 of pseudo-code 600 specifies a value Cust_Util_tgt as being a ratio of a high utilization threshold LIs_hu % for the information storage metric to a current target subscription level LSub_tgt %.

Lines 3 through 5 of pseudo-code 600 set forth a condition for revising (setting a new value for) the target subscription level LSub_tgt %. In the illustrative embodiment, if Cust_Util_act is greater than Cust_Util_tgt—e.g. an indicia of a type of high utilization of subscribed volume—then the target subscription level LSub_tgt % is set to a product of the current subscription level LSub % and a ratio of the high utilization threshold LIs_hu % to the current level LIs %. In an embodiment, the new value for subscription level LSub % may be used to calculate an estimated amount of subscription headroom.

FIG. 6B is a listing of pseudo-code 610 representing elements of another technique for calculating the target subscription level LSub_tgt % according to an embodiment. In an embodiment, calculation of LSub_tgt % with pseudo-code 610 is for circumstances different from that for calculation with pseudo-code 600. By way of illustration and not limitation, pseudo-code 610 may be used to calculate some first value for LSub_tgt % upon initialization of a storage pool, and pseudo-code 600 may be subsequently used to revise the initial value for LSub_tgt %

Line 1 of pseudo-code 610 set forth a first condition for determining LSub_tgt %, the first condition including LSub % being greater than or equal to its corresponding high utilization threshold LSub_hu %, and an age Pool_Age of the storage pool being greater than some threshold time Pool_check for dynamically updating LSub_tgt %. If the condition of line 1 is met, then line 2 of pseudo-code 610 sets Sub_tgt % to the maximum of the current subscription level LSub % and the value used in line 4 of pseudo-code 600. Pseudo-code 610 assumes some previous setting of a value for Cust_Util_act—e.g. similar to the setting of Cust_Util_act in Line 1 of pseudo-code 600. Lines 3 through 5 of pseudo-code 610 assert that if the condition of line 1 is not met, then the target subscription level Sub_tgt % is set to some default value Sub_tgt_default % —e.g. 100%.

Pseudo-code 600 and pseudo-code 610 each include respective operations which variously evaluate or otherwise use a current level LIs % and high utilization threshold LIs_hu % for an information storage metric. However, calculation of target subscription level Sub_tgt % may alternatively be performed with corresponding use of a current level and threshold of any of a variety of other metrics, according to different embodiments.

FIG. 6C is a listing of pseudo-code 620 representing elements of a technique for calculating subscription headroom information according to an embodiment. One or more values calculated according to the operations represented by pseudo-code 620 may be described in the signal generated at 330 of method 300. For example, some or all such values may be calculated in response to classification of a storage pool—e.g. at 320 of method 300.

Lines 1 of pseudo-code 620 specifies that lines 2 through 4 pertain to a situation where the storage pool is classified as being in an open state. In such a situation, line 2 of pseudo-code 620 sets a value Subscribed_max for representing the maximum allowable subscription volume to be equal to a product of the size PoolSize of the storage pool and the target subscription level LSub_tgt %. The value of LSub_tgt % used in line 2 may be determined by pseudo-code 600 or pseudo-code 610, for example. Line 3 of pseudo-code 620 sets a volume value Subscribed_hdrm for representing the subscription headroom estimation to be equal to a difference between the value Subscribed_max and the volume value LSub (e.g. in bytes) for the current subscription level. Line 4 of pseudo-code 620 sets a ratio value Subscribed_hdrm % for representing the subscription headroom estimation to be equal to a quotient of the volume value Subscribed_hdrm and the value Subscribed_max.

Line 5 of pseudo-code 620 specifies that lines 6 through 9 pertain to a situation where the storage pool is classified as not being in the open state. In such a situation, line 6 of pseudo-code 620 sets Subscribed_max to be equal to the current level of subscription LSub. Line 7 of pseudo-code 620 sets volume value Subscribed_hdrm to zero (0). Line 8 of pseudo-code 620 sets ratio value Subscribed_hdrm % to zero (0).

To demonstrate features of certain embodiment, an illustrative scenario for estimating subscription headroom is shown in the following example:

### Example 1

| PoolSIZE: | 10TB |
|---|---|
| LSub: | 5TB |
| LIs: | 4TB |
| LSub_tgt %: | 150% |
| LIs_hu %: | 70% |

| | |
|---|---|
| T1: | ( LIs / LSub ) > ( LIs_hu % / LSub_tgt % ) ? |
| | [ ( 4TB / 5TB ) > ( 70% / 150% ) ] = TRUE |
| T2: | MAX [ ( LIs_hu % * LSub ) / ( LIs ) , ( LSub / PoolSIZE ) ] |
| | MAX [ (70% * 5TB) / (4TB) , ( 5TB ) / ( 10TB ) ] |
| | 87.5% = LSub_tgt_new % |

| | |
|---|---|
| Subscribed_max: | PoolSIZE * LSub_tgt_new % = 8.75TB |
| Subscribed_hdrm: | Subscribed_max − LSub = 8.75TB − 5TB = |
| | 3.75TB |

In the above example, calculation of a target subscription level LSub_tgt differs from the calculation shown either of FIGS. 6A and 6B. More particularly, the above example includes evaluating a test condition T1 to determine whether to revise the value for the target subscription level LSub_tgt %. The test condition T1 may correspond to that of line 3 in pseudo-code 600, for example. In response to determining that the test condition T1 has been met, the above example calculates a revised value for LSub_tgt % —LSub_tgt_new % —using a calculation which may, for example, correspond to that of line 2 in pseudo-code 610. Based on the calculated value LSub_tgt_new %, the above example calculates a new maximum subscription volume estimate Subscribed_max of 8.75TB—i.e. calculates an estimated 3.75TB of subscription headroom above the current 5TB of subscribed volume.

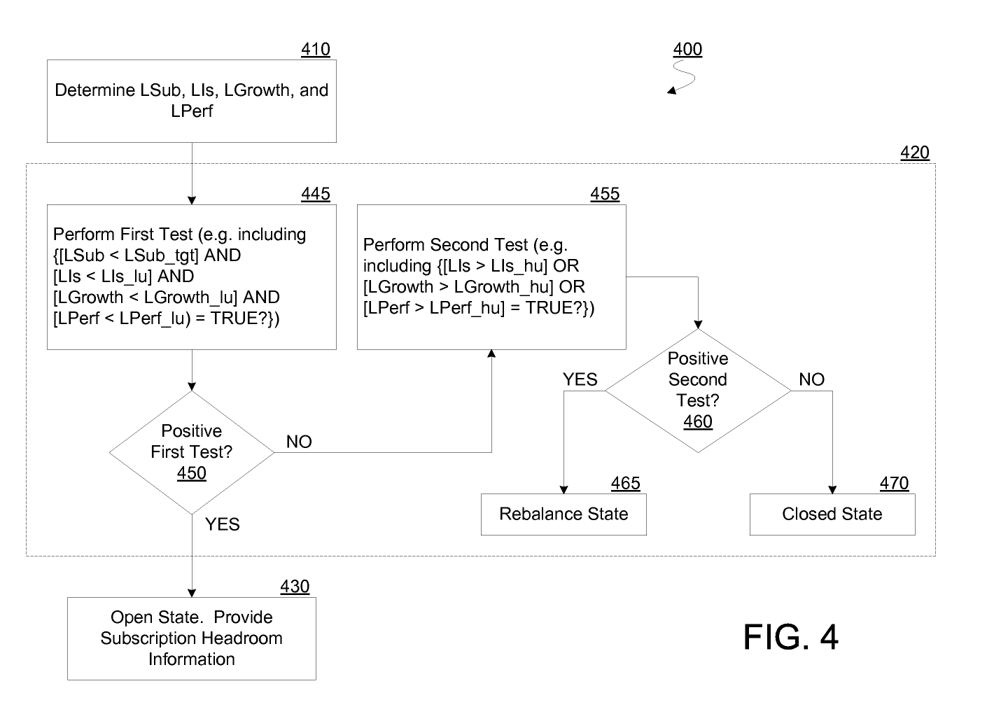

FIG. 4 illustrates elements of a method to detect subscription headroom according to an embodiment. Method 300 may be performed with circuit logic having some or all of the features of pool manager 200, for example. In an embodiment, method 400 includes some or all of the features of method 300.

Method 400 may include, at 410, determining a current subscription level LSub for a storage pool and current levels LIs, LGrowth, LPerf for, respectively, an information storage metric, a growth metric and an access performance metric. The determining at 410 may correspond to the determining at 310, although certain embodiments are not limited in this regard.

Method 400 may further include one or more operations 420 classifying the storage pool. The operations may, for example, correspond to the classifying at 320. In an embodiment, one or more operations 420 include performing a first test at 445 to determine whether utilization of the storage pool is sufficiently low to indicate the availability of subscription headroom. By way of illustration and not limitation, performing the first test at 445 may include comparing the current subscription level SLSub with a target subscription level LSub_tgt, and comparing current levels LIs, LGrowth, LPerf with low utilization threshold values LIs lu, LGrowth lu, LPerf lu, respectively. Table 1 below show examples of target and threshold values which are variously associated with respective ones of the current subscription level and the information storage metric, growth metric and access performance metric.

TABLE 1
Sample Target/Threshold Values for
Detecting Subscription Headroom

| | Low Utilization | | High Utilization | |
|---|---|---|---|---|
| Risk Factor | Threshold | | Threshold | |
| Subscription | 150% | (LSub_tgt %) | N/A | |
| Percentage | | | | |
| Information | 50%-60% | (LIs_lu %) | 70%-80% | (LIs_hu %) |
| Storage | | | | |
| Percentage | | | | |
| Growth (TTF) | 26 weeks | (LGrowth_lu) | 13 weeks | (LGrowth_hu) |
| Performance | 95% | (LPerf_lu %) | 105% | (LPerf_hu %) |

However, the particular values shown in Table 1 are merely illustrative, and such values may vary widely according to application-specific conditions. Accordingly, the values of Table 1 are not limiting on certain embodiments.

Comparisons of such risk factors with respective target or thresholds values may—depending on the nature of the metrics—variously include one or a less-than comparison, a less-than-or-equal-to comparison, a greater-than comparison and a greater-than-or-equal-to comparison. In an illustrative scenario, low utilization testing at 445 includes respective less-than comparisons for each of the information storage metric, a growth metric and/or an access performance metric. However, low utilization may alternatively be identified by detecting a sufficiently large level for a given metric. For example, the growth metric for LGrowth may alternatively be a time-to-fill (TTF) metric, where low utilization is represented by a comparatively large time for an expected filling of a storage pool, and where high utilization is represented by a comparatively small time for the expected filling of a storage pool. In such an instance, a low utilization threshold for a TTF metric may be larger in value than a high utilization threshold for that TTF metric.

In an embodiment, one or more operations 420 include determining at 450 whether the test for low utilization at 445 generated a positive result. The positive result may include low utilization being indicated in combination by each of the respective conditions evaluated for the current subscription level and the information storage metric, a growth metric and an access performance metric.

Where the first test is determined at 450 to be positive—e.g. indicating sufficiently low storage pool utilization—method 400 may, at 430, indicate that the storage pool is classified as being in an open state. In an embodiment, indicating the open state at 430 includes providing subscription headroom information such as one or more of a ratio value (Subscribed_hdrm %) of the estimated subscription headroom, a volume amount (Subscribed_hdrm) of the estimated subscription headroom, a maximum allowed subscription amount (Subscribed_max) to account for the estimated subscription headroom, and/or other such headroom information.

Where the first test is determined at 450 to be negative, one or more operations 420 may perform a second test at 455 to determine whether utilization of the storage pool is sufficiently high to indicate resource rebalancing. By way of illustration and not limitation, performing the second test at 455 may include comparing current levels Lb, LGrowth, LPerf with high utilization threshold values LIs_hu, LGrowth hu, LPerf hu, respectively. As discussed with respect to the first test at 455, one or more such comparisons may—depending on the nature of the metric—variously include one or a less-than comparison, a less-than-or-equal-to comparison, a greater-than comparison and a greater-than-or-equal-to comparison. The second test at 455 may forego any evaluation of LSub, although certain embodiments are not limited in this regard.

One or more operations 420 may include determining at 460 whether the test for high utilization at 455 generated a positive result. The positive result may include detecting that high utilization is indicated by at least one the metric conditions evaluated at 455. Where the second test is determined at 460 to be positive—e.g. indicating sufficiently high storage pool utilization—method 400 may, at 465, indicate that the storage pool is classified as being in a rebalance state. Identifying the rebalance state at 465 may, in an embodiment, trigger one or more operations (not shown) to suspend any additional subscription of storage volume and to initiate rebalancing of storage pool resources. Where the second test is determined at 460 to be negative, method 400 may, at 470, indicate that the storage pool is classified as being in a closed state. Identifying the closed state at 470 may, in an embodiment, trigger one or more operations (not shown) to suspend any additional subscription of storage volume—e.g. without initiating any such rebalancing of storage pool resources.

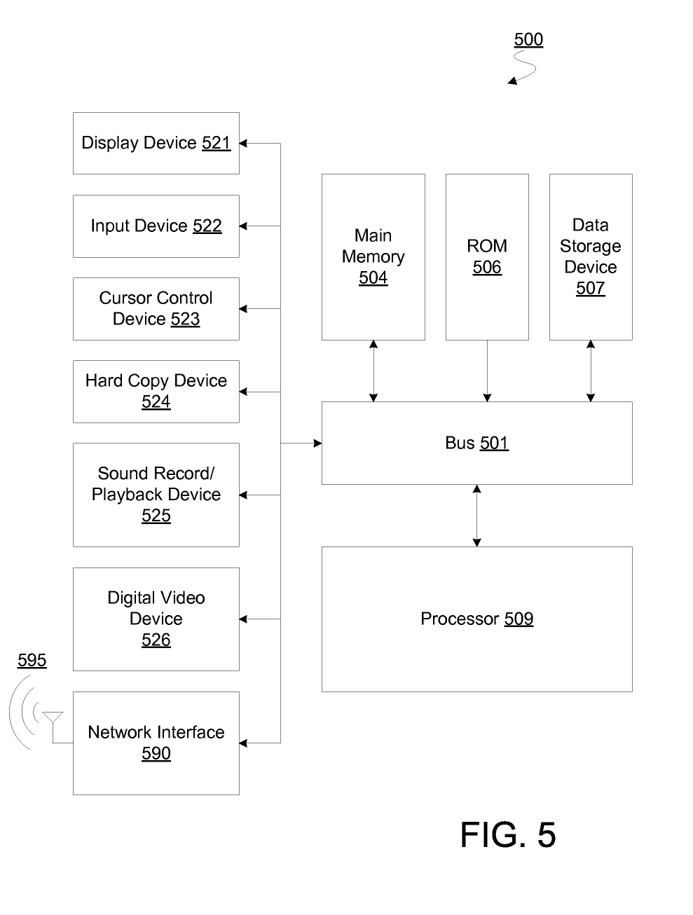

FIG. 5 shows elements of an illustrative computer platform 500 for determining subscription headroom information according to one embodiment. Computer platform 500 may, for example, include a hardware platform of a computer such as a server, workstation, desktop computer, laptop computer, a handheld computer—e.g. a tablet, palmtop, cell phone, media player, and/or the like—and/or other such computer system. Alternatively, embodiments may be implemented in one or more embedded applications where, for example, an embedded processor is to implement subscription headroom processing or any of a variety of other applications involving managing a storage pool.

In an embodiment, computer platform 500 includes at least one interconnect, represented by an illustrative bus 501, for communicating information and a processor 509—e.g. a central processing unit—for processing such information. Processor 509 may include functionality of a complex instruction set computer (CISC) type architecture, a reduced instruction set computer (RISC) type architecture and/or any of a variety of processor architecture types. Processor 509 may couple with one or more other components of computer platform 500 via bus 501. By way of illustration and not limitation, computer platform 500 may include a random access memory (RAM) or other dynamic storage device, represented by an illustrative main memory 504 coupled to bus 501, to store information and/or instructions to be executed by processor 509. Main memory 504 also may be used for storing temporary variables or other intermediate information during execution of instructions by processor 509. Computer platform 500 may additionally or alternatively include a read only memory (ROM) 506, and/or other static storage device—e.g. where ROM 506 is coupled to processor 509 via bus 501—to store static information and/or instructions for processor 509.

In an embodiment, computer platform 500 additionally or alternatively includes a data storage device 507 (e.g., a magnetic disk, optical disk, and/or other machine readable media) coupled to processor 509—e.g. via bus 501. Data storage device 507 may, for example, include instructions or other information to be operated on and/or otherwise accessed by processor 509. In an embodiment, processor 509 may perform subscription headroom calculations based on storage pool information stored in main memory 504, ROM 506, data storage device 507 or any other suitable data source.

Computer platform 500 may additionally or alternatively include a display device 521 for displaying information to a computer user. Display device 521 may, for example, include a frame buffer, a specialized graphics rendering device, a cathode ray tube (CRT), a flat panel display and/or the like. Additionally or alternatively, computer platform 500 may include an input device 522—e.g. including alphanumeric and/or other keys to receive user input. Additionally or alternatively, computer platform 500 may include a cursor control device 523, such as a mouse, a trackball, a pen, a touch screen, or cursor direction keys to communicate position, selection or other cursor information to processor 509, and/or to control cursor movement—e.g. on display device 521.

Computer platform 500 may additionally or alternatively have a hard copy device 524 such as a printer to print instructions, data, or other information on a medium such as paper, film, or similar types of media. Additionally or alternatively, computer platform 500 may include a sound record/playback device 525 such as a microphone or speaker to receive and/or output audio information. Computer platform 500 may additionally or alternatively include a digital video device 526 such as a still or motion camera to digitize an image.

In an embodiment, computer platform 500 includes or couples to a network interface 590 for connecting computer platform 500 to one or more networks (not shown)—e.g. via one or more antennae 595. Such one or more networks may, for example, include a dedicated storage area network (SAN), a local area network (LAN), a wide area network (WAN), a virtual LAN (VLAN), an Internet and/or any of a variety of other types of networks. By way of illustration and not limitation, network interface 590 may include one or more of a network interface card (NIC), an antenna such as a dipole antenna, or a wireless transceiver, although the scope of the present invention is not limited in this respect.

In one aspect, an apparatus comprises classification logic to determine a current subscription level for a storage pool and a respective current level of each of one or more metrics for the storage pool, the classification logic further to classify the storage pool, including the classification logic to test for a combination of respective low utilization conditions for each of the subscription level and the one or more metrics. The apparatus further comprises subscription logic coupled to the classification logic, the subscription logic to automatically determine a target subscription level based on the current subscription level, a first metric of the one or more metrics, and a high utilization threshold corresponding to the first metric, wherein, where the classification logic detects the combination, the subscription logic further to generate a first signal based on the target subscription level, the first signal to indicate availability of subscription headroom.

In an embodiment, the one or more metrics includes an information storage metric, a growth metric or an access performance metric. In an embodiment, the growth metric includes a time-to-fill metric describing a time when the storage pool is expected to be full.

In an embodiment, the one or more metrics each correspond to a respective low utilization threshold, wherein the classification logic to test for the combination comprises the classification logic to compare the current subscription level with a threshold subscription level, and for each of the one or more metrics, the classification logic to compare the current level for the metric to the corresponding low utilization threshold.

In an embodiment, the one or more metrics each correspond to a respective high utilization threshold, the classification logic to classify the storage pool further including for each of the one or more metrics, the classification logic to perform a respective high utilization test based on the high utilization threshold corresponding to the metric, and where any of the high utilization tests indicates high utilization, the classification logic to generate a second signal to indicate a rebalance of one or more storage pool resources. In an embodiment, the second signal is to indicate addition of physical storage volume to the storage pool.

In an embodiment, the classification logic is further to calculate the target subscription level based on a product of the current subscription level and a ratio of the high utilization threshold corresponding to the first metric to the current level of first metric. In an embodiment, the classification logic to calculate the target subscription level based on the product includes the classification logic to select a maximum of the product and the current subscription level. In an embodiment, the classification logic is further to calculate the target subscription level, including the classification logic to compare a first ratio of a current level of an information storage metric to the current subscription level with a second ratio of a high utilization threshold of the information storage metric to a current target subscription level. In an embodiment, the one or more metrics includes a metric other than any metric which is a component of the target subscription level.

In another aspect, a method comprises determining a current subscription level for a storage pool and a respective current level of each of one or more metrics for the storage pool, and classifying the storage pool, including testing for a combination of respective low utilization conditions for each of the subscription level and the one or more metrics. The method further comprises, where the testing indicates the combination, generating a first signal indicating availability of subscription headroom, including determining a target subscription level based on the current subscription level, a first metric of the one or more metrics, and a high utilization threshold corresponding to the first metric.

In an embodiment, the one or more metrics includes a metric other than any metric which is a component of the target subscription level. In an embodiment, the one or more metrics each correspond to a respective low utilization threshold, wherein testing for the combination comprises comparing the current subscription level with a threshold subscription level and, for each of the one or more metrics, comparing the current level for the metric to the corresponding low utilization threshold.

In an embodiment, the one or more metrics each correspond to a respective high utilization threshold, the classifying the storage pool further including, for each of the one or more metrics, performing a respective high utilization test based on the high utilization threshold corresponding to the metric, and, where any of the high utilization tests indicates high utilization, generating a second signal indicating a rebalance of one or more storage pool resources.

In an embodiment, the method further comprises calculating the target subscription level based on a product of the current subscription level and a ratio of the high utilization threshold corresponding to the first metric to the current level of first metric. In an embodiment, calculating the target subscription level based on the product includes selecting a maximum of the product and the current subscription level. In an embodiment, the method further comprises calculating the target subscription level, including comparing a first ratio of a current level of an information storage metric to the current subscription level with a second ratio of a high utilization threshold of the information storage metric to a current target subscription level.

In an embodiment, the one or more metrics includes an information storage metric, a growth metric or an access performance metric. In an embodiment, the growth metric includes a time-to-fill metric describing a time when the storage pool is expected to be full. In an embodiment, the method further comprises calculating the subscription headroom based on the current subscription level and a target subscription level.

In another aspect, one or more computer-readable storage media have stored thereon instructions which, when executed by one or more processing units, cause the one or more processing units to perform a method comprising determining a current subscription level for a storage pool and a respective current level of each of one or more metrics for the storage pool, and classifying the storage pool, including testing for a combination of respective low utilization conditions for each of the subscription level and the one or more metrics. The method further comprises, where the testing indicates the combination, generating a first signal indicating availability of subscription headroom, including determining a target subscription level based on the current subscription level, a first metric of the one or more metrics, and a high utilization threshold corresponding to the first metric.

In an embodiment, the one or more metrics includes a metric other than any metric which is a component of the target subscription level. In an embodiment, the one or more metrics each correspond to a respective low utilization threshold, wherein testing for the combination comprises comparing the current subscription level with a threshold subscription level and, for each of the one or more metrics, comparing the current level for the metric to the corresponding low utilization threshold.

In an embodiment, the one or more metrics each correspond to a respective high utilization threshold, the classifying the storage pool further including, for each of the one or more metrics, performing a respective high utilization test based on the high utilization threshold corresponding to the metric, and where any of the high utilization tests indicates high utilization, generating a second signal indicating a rebalance of one or more storage pool resources.

In an embodiment, the method further comprises calculating the target subscription level based on a product of the current subscription level and a ratio of the high utilization threshold corresponding to the first metric to the current level of first metric. In an embodiment, calculating the target subscription level based on the product includes selecting a maximum of the product and the current subscription level. In an embodiment, the method further comprises calculating the target subscription level, including comparing a first ratio of a current level of an information storage metric to the current subscription level with a second ratio of a high utilization threshold of the information storage metric to a current target subscription level.

In an embodiment, the one or more metrics includes an information storage metric, a growth metric or an access performance metric. In an embodiment, the growth metric includes a time-to-fill metric describing a time when the storage pool is expected to be full. In an embodiment, the method further comprises calculating the subscription headroom based on the current subscription level and a target subscription level.

Techniques and architectures for managing a storage pool are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in one or more computer readable storage media, including, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. An apparatus comprising:
classification logic to determine a current subscription level for a storage pool and a respective current level of each of one or more metrics for the storage pool, the classification logic further to classify the storage pool, including the classification logic to test for a combination of respective low utilization conditions for each of the subscription level and the one or more metrics; and
subscription logic coupled to the classification logic, the subscription logic to automatically determine a target subscription level based on the current subscription level, a first metric of the one or more metrics, and a high utilization threshold corresponding to the first metric, wherein, where the classification logic detects the combination, the subscription logic further to generate a first signal based on the target subscription level, the first signal to indicate availability of subscription headroom.

2. The apparatus of claim 1, wherein the one or more metrics includes an information storage metric, a growth metric or an access performance metric.

3. The apparatus of claim 2, wherein the growth metric includes a time-to-fill metric describing a time when the storage pool is expected to be full.

4. The apparatus of claim 1, wherein the one or more metrics each correspond to a respective low utilization threshold, and wherein the classification logic to test for the combination comprises:
the classification logic to compare the current subscription level with a threshold subscription level; and
for each of the one or more metrics, the classification logic to compare the current level for the metric to the corresponding low utilization threshold.

5. The apparatus of claim 1, wherein the one or more metrics each correspond to a respective high utilization threshold, the classification logic to classify the storage pool further including:
for each of the one or more metrics, the classification logic to perform a respective high utilization test based on the high utilization threshold corresponding to the metric; and
where any of the high utilization tests indicates high utilization, the classification logic to generate a second signal to indicate a rebalance of one or more storage pool resources.

6. The apparatus of claim 5, wherein the second signal to indicate addition of physical storage volume to the storage pool.

7. The apparatus of claim 1, the classification logic further to calculate the target subscription level based on a product of the current subscription level and a ratio of the high utilization threshold corresponding to the first metric to the current level of the first metric.

8. The apparatus of claim 7, wherein the classification logic to calculate the target subscription level based on the product includes the classification logic to select a maximum of the product and the current subscription level.

9. The apparatus of claim 1, the classification logic further to calculate the target subscription level, including the classification logic to compare a first ratio of a current level of an information storage metric to the current subscription level with a second ratio of a high utilization threshold of the information storage metric to a current target subscription level.

10. The apparatus of claim 1, wherein the one or more metrics includes a metric other than any metric which is a component of the target subscription level.

11. A method comprising:
determining a current subscription level for a storage pool and a respective current level of each of one or more metrics for the storage pool;
classifying the storage pool, including testing for a combination of respective low utilization conditions for each of the subscription level and the one or more metrics; and
where the testing indicates the combination, generating a first signal indicating availability of subscription headroom, including determining a target subscription level based on the current subscription level, a first metric of the one or more metrics, and a high utilization threshold corresponding to the first metric.

12. The method of claim 11, wherein the one or more metrics includes a metric other than any metric which is a component of the target subscription level.

13. The method of claim 11, wherein the one or more metrics each correspond to a respective low utilization threshold, and wherein testing for the combination comprises:
comparing the current subscription level with a threshold subscription level; and
for each of the one or more metrics, comparing the current level for the metric to the corresponding low utilization threshold.

14. The method of claim 11, wherein the one or more metrics each correspond to a respective high utilization threshold, the classifying the storage pool further including:
for each of the one or more metrics, performing a respective high utilization test based on the high utilization threshold corresponding to the metric; and
where any of the high utilization tests indicates high utilization, generating a second signal indicating a rebalance of one or more storage pool resources.

15. The method of claim 11, further comprising calculating the target subscription level based on a product of the current subscription level and a ratio of the high utilization threshold corresponding to the first metric to the current level of the first metric.

16. The method of claim 15, wherein calculating the target subscription level based on the product includes selecting a maximum of the product and the current subscription level.

17. The method of claim 11, further comprising calculating the target subscription level, including comparing a first ratio of a current level of an information storage metric to the current subscription level with a second ratio of a high utilization threshold of the information storage metric to a current target subscription level.

18. The method of claim 11, wherein the one or more metrics includes an information storage metric, a growth metric or an access performance metric.

19. The method of claim 18, wherein the growth metric includes a time-to-fill metric describing a time when the storage pool is expected to be full.

20. The method of claim 11, further comprising calculating the subscription headroom based on the current subscription level and a target subscription level.

21. One or more computer-readable storage media having stored thereon instructions which, when executed by one or more processing units, cause the one or more processing units to perform a method comprising:
determining a current subscription level for a storage pool and a respective current level of each of one or more metrics for the storage pool;
classifying the storage pool, including testing for a combination of respective low utilization conditions for each of the subscription level and the one or more metrics;
where the testing indicates the combination, generating a first signal indicating availability of subscription headroom, including determining a target subscription level based on the current subscription level, a first metric of the one or more metrics, and a high utilization threshold corresponding to the first metric.

22. The one or more computer-readable storage media of claim 21, wherein the one or more metrics includes a metric other than any metric which is a component of the target subscription level.

23. The one or more computer-readable storage media of claim 21, wherein the one or more metrics each correspond to a respective low utilization threshold, and wherein testing for the combination comprises:
comparing the current subscription level with a threshold subscription level; and
for each of the one or more metrics, comparing the current level for the metric to the corresponding low utilization threshold.

24. The one or more computer-readable storage media of claim 21, wherein the one or more metrics each correspond to a respective high utilization threshold, the classifying the storage pool further including:
for each of the one or more metrics, performing a respective high utilization test based on the high utilization threshold corresponding to the metric; and
where any of the high utilization tests indicates high utilization, generating a second signal indicating a rebalance of one or more storage pool resources.

25. The one or more computer-readable storage media of claim 21, the method further comprising calculating the target subscription level based on a product of the current subscription level and a ratio of the high utilization threshold corresponding to the first metric to the current level of the first metric.

26. The one or more computer-readable storage media of claim 25, wherein calculating the target subscription level based on the product includes selecting a maximum of the product and the current subscription level.

27. The one or more computer-readable storage media of claim 21, the method further comprising calculating the target subscription level, including comparing a first ratio of a current level of an information storage metric to the current subscription level with a second ratio of a high utilization threshold of the information storage metric to a current target subscription level.

28. The one or more computer-readable storage media of claim 21, wherein the one or more metrics includes an information storage metric, a growth metric or an access performance metric.

29. The one or more computer-readable storage media of claim 28, wherein the growth metric includes a time-to-fill metric describing a time when the storage pool is expected to be full.

30. The one or more computer-readable storage media of claim 21, the method further comprising calculating the subscription headroom based on the current subscription level and a target subscription level.
